(19) United States
(12) Patent Application Publication
(10) Pub. No.: US 2014/0141202 A1
(43) Pub. Date: May 22, 2014

(54) Screen Protection Application Film

(71) Applicant: SHANGHAI BENPU TECHNOLOGY DEVELOPMENT CO.,, Shanghai (CN)

(72) Inventor: Fei Ma, Shanghai (CN)

(73) Assignee: Shanghai BENPU Technology Development Co., Ltd, Shaghai (CN)

(21) Appl. No.: 13/709,053

(22) Filed: Dec. 9, 2012

(30) Foreign Application Priority Data
Nov. 19, 2012 (CN) 201210470501.7

(51) Int. Cl. B32B 3/30

(52) U.S. Cl. CPC B32B 3/30
USPC 428/156

(57) ABSTRACT

A screen protection application film, includes a protection film (1) and a back adhesive layer (2), a backing paper (3), in which the back side of the protection film (1) include a screen protection area (11) and a panel protection area (12), the front side of the back adhesive layer (2) is bonded to the back side of the protection film (1), the front side of the backing paper (3) connects with the back side of the protection film (1) through the back adhesive layer (2), the extending plane of the back adhesive layer (2) is only limited to the panel protection area (12), the protection film (1) extends toward the back side direction to form multiple convex parts (10) and there is a gap (9) between the screen protection area (11) and the back paper (3).

### BACKGROUND OF THE PRESENT INVENTION

1. Field of Invention

This invention relates to an application film for screen protection and especially for the touch screens of hand-held electric equipment. More specifically, it related to a screen protection application film.

2. Description of Related Arts

Protected by an application film, the touch screens of hand-held electronic equipment can be free from damages due to scratching, oil, etc. The following two types of application films are common in existing technology:

One type is that the whole application film area is in a composite layer structure. For example, a utility model patent with a publication number of CN202261425U and called as “an application film for mobile phones” made public a kind of three-layer composite structure. The shortcoming is that unskillful users tend to generate bubbles in applying films.

The other type is that local application film area adopts a composite structure. For example, the invention application with a publication number of CN102508522A and called as “touch screen protector” made public a containing plastic film and spacers distributed on the outer edge area of the plastic film. The shortcoming is that the patent provides particles on the rear side of the plastic film to produce an anti-static effect, which is a method with a complicated manufacture process. Besides, with printing particle mode adopted, the technical scheme of the invention application is easy to cause non-conformance products and non-durability (such as non-resistance to wearing) and it is unable to accurately achieve an equal interval between particles. Therefore, the particle distribution is not uniform that influences anti-static effect and such optical effects as avoidance of light splitting and increase of definition, etc.

### SUMMARY OF THE PRESENT INVENTION

In view of such defects in existing technologies, the purpose of this invention is to provide a screen protection film.

According to one aspect of this invention, a screen protection application film is provided, comprising a protection film and also comprising a back adhesive layer, and a backing paper, in which the back side of the protection film includes a screen protection area and a panel protection area, the front side of the backing paper connects with the back side of the protection film through the back adhesive layer, the extending area of the back adhesive layer is only limited to the panel protection area, the protection film extends in the screen protection area toward the back side direction to form multiple convex parts and there is a gap between the screen protection area and the backing paper.

Preferably, the heights of the convex parts are less than or equal to the thickness of the back adhesive layer.

Preferably, the convex parts form a dot array in any of the following shape distribution:

Fold line shape;

Grid shape;

Concentric ring shape; and

Multi-point radiating line shape.

Preferably, the convex parts are formed through pressing.

Preferably, there is an interval between the convex parts.

Preferably, the interval between the convex parts is 0.05-0.5 mm.

Preferably, the thickness of the back adhesive layer is 0.05-1 m.

Preferably, the thickness of the protection film is 0.1-1 mm and the thickness of the back adhesive layer is 0.05-1 mm.

Preferably, the printing layer is also included and the printing layer is placed between the protection film and back adhesive layer.

Preferably, the convex parts are in hemispherical shape, prism shape and cone shape.

In comparison with existing technologies, this invention has the following beneficial effects:

1. After multiple convex parts on the back side of protection film are designed, static electricity can be eliminated (anti-static) and the application film is easy to apply.

2. The convex parts are made by means of mould pressing with a simple and stable process, and the air pollution during particle spray coating is avoided with the requirement for air cleanness reduced.

3. Through such design as providing convex parts on the back side, the application film becomes durable with a high product conformance rate.

4. Through forming the convex parts by means of mould pressing, the interval between the convex parts can be accurately controlled so that the convex parts distribute evenly on the back side of protection film to realize a good anti-static effect and such optical effects as avoidance of light splitting and increase of definition. With particles being provided on protection film by means of spray coating, the requirement of even distribution can not be achieved due to difficulty in controlling the interval between particles.

### BRIEF DESCRIPTION OF THE DRAWINGS

Through reading and referring to the detailed descriptions of the following figures to unlimited embodiment examples, other characteristics, purposes and advantages of this invention will become more conspicuous:

FIG. 1 shows the schematic structure of the back side of the screen protection film provided by this invention after the backing paper is removed;

FIG. 2 shows the schematic sectional structure of the screen protection film provided according to this invention;

FIG. 3 shows the schematic structure of the screen protection area and panel protection area of the screen protection film provided according to this invention;

FIG. 4 shows the schematic principle of bonding the back paper to the back adhesive layer;

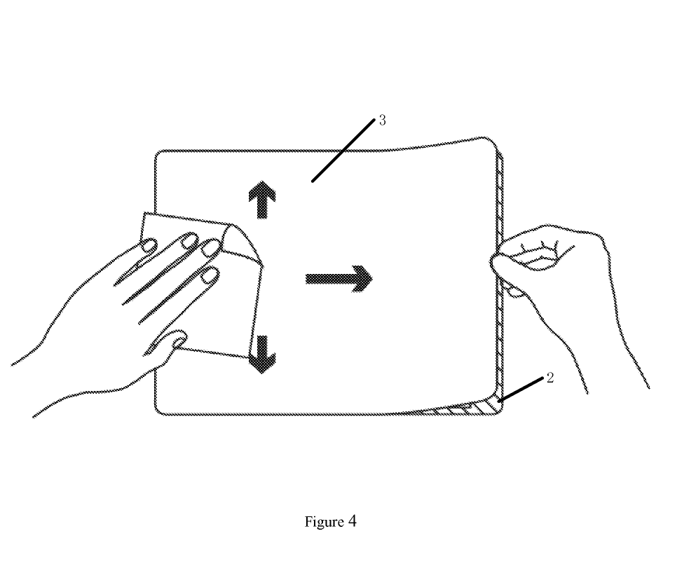

FIG. 5 shows the schematic principle of removing the backing paper from the back adhesive layer;

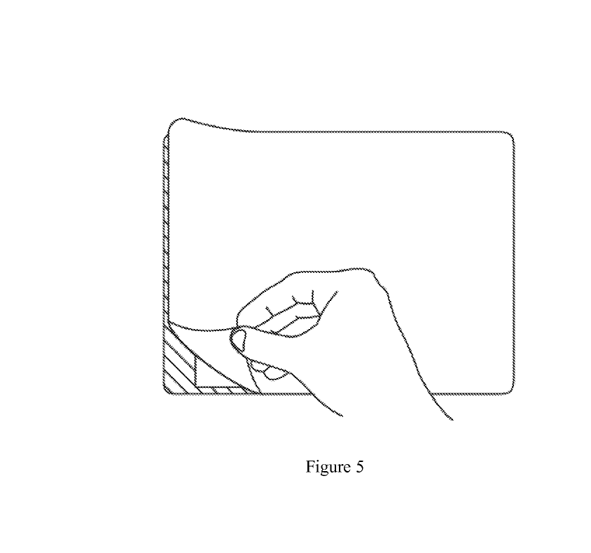

FIG. 6 shows the schematic principle of applying the protection film onto the wiping front side of a mobile phone;

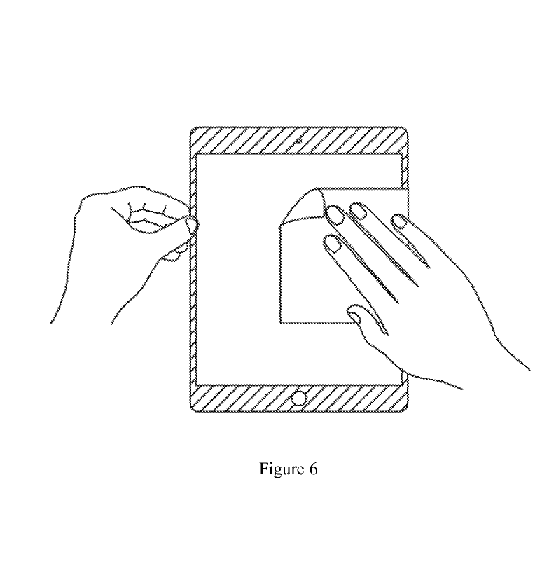

FIG. 7 shows the schematic of a mobile phone applied with a protection film.

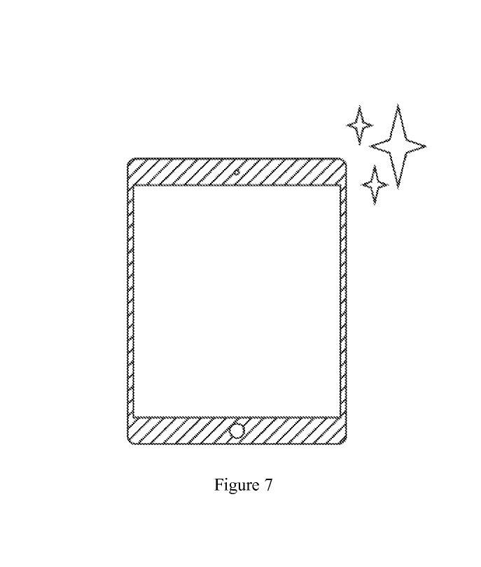

### DETAILED DESCRIPTION OF THE PREFERRED EMBODIMENT

This invention is to be described in detail below in combination with specific embodiment examples. The following embodiment examples will be helpful for technical persons in this field to further understand this invention, but will not limit this invention in any way. It should be pointed out that as far as ordinary technical persons in this field are concerned, they can make some changes and improvements under the prerequisite of not divorcing from the conceiving of this invention. All these fall in the protection scope of this invention.

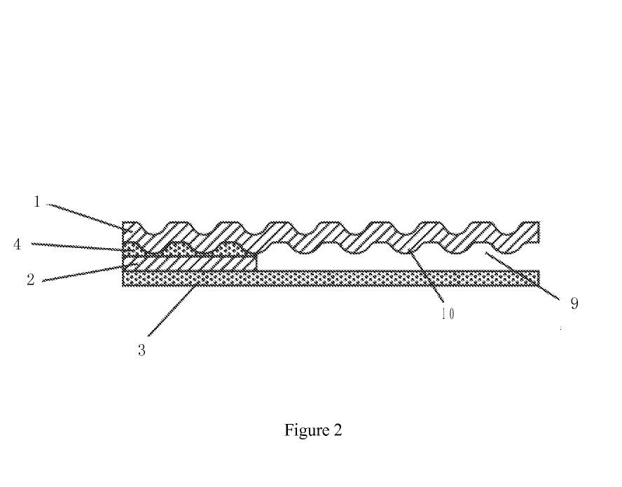

In an embodiment example of this invention, the screen protection film provided according to this invention is used for application to the screens of hand-held equipment, for example, it can be applied to the screen of a mobile phone or a tablet computer. The screen protection application film, as shown in FIG. 2, includes a protection film 1, a back adhesive layer 2 with a certain thickness, a backing paper 3 and a printing layer 4, in which the back side of the protection film includes a screen protection area 11 and a panel protection area 12, the front side of the back adhesive layer 2 is bonded to the back side of the protection film 1, the front side of the backing paper 3 connects with the back side of the protection film 1 through the back adhesive layer 2, the extending plane of the back adhesive layer 1 is limited within the panel protection area 12, the printing layer 4 is placed between the protection film 1 and back adhesive layer 2, a gap 9 exists between the screen protection area 11 and the backing paper 3, the protection film 1 extends toward the back side direction to form multiple convex parts 10 and preferably, the protection film 1 extends toward the back side direction to form multiple convex parts 10 only in the screen protection area 11.

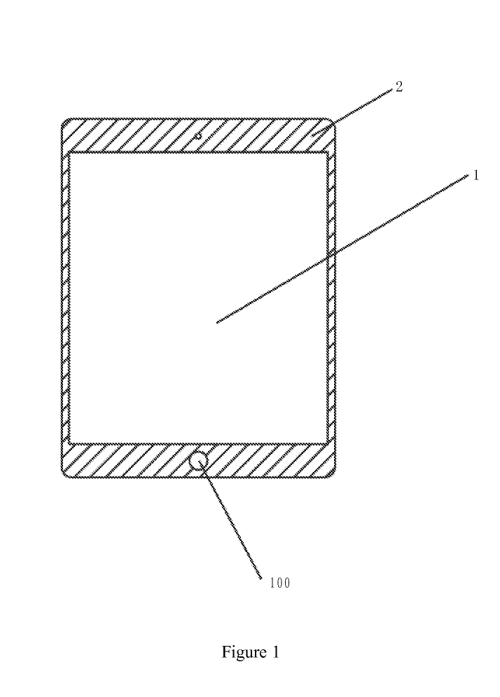

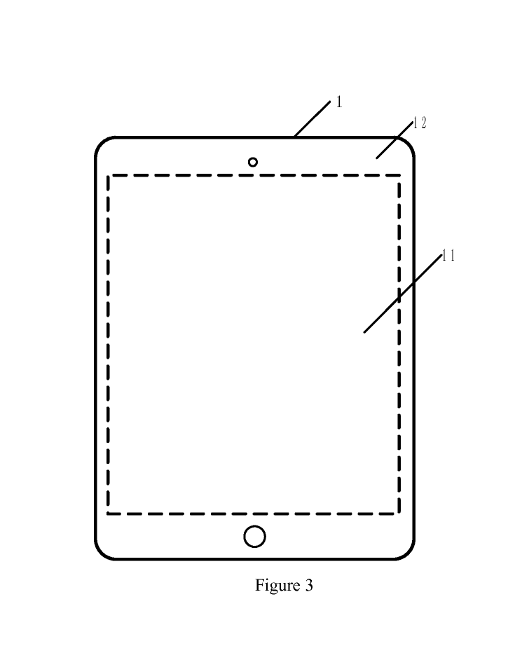

As shown in FIG. 3, the area and shape of the screen protection area 11 is consistent or matches with the effective display area of hand-held equipment screen and the area and shape of the panel protection area 12 is consistent or match with the panel area of hand-held equipment screen, in which, the match may imply similarity in shape and may also mean that part of the panel protection area 12 is in a hollowed-out structure so that such components as a camera, a microphone, a press key, etc. are kept from being covered by the protection film, for example, the hollowed-out area 100 corresponding to the press keys as shown in FIG. 1. In this embodiment example, the protection film 1 is in an integral structure only for the purpose to identify clearly and a broken line is used to distinguish between the screen protection area 11 and the panel protection area 12; in the variants of this embodiment example, the screen protection area 11 and the panel protection area 12 can also be made of different materials.

More specifically, the heights of the convex parts 10 are less than or equal to the thickness of the back adhesive layer 2, which in a fold line shape. In the variants of this embodiment example, the convex parts 10 can also form a dot array of different shapes in grid shape or concentric ring shape distribution. The convex parts 10 themselves can be in hemispherical shape, prism shape or cone shape.

Further, the convex parts 10 are formed by pressing. Technical persons in this field can refer to pressing means in existing technology to achieve the convex parts 10 and no redundant explanation is made here. Through setting of different pressing parameters, an interval can be produced between the convex parts 10. In a preferred case of this embodiment example, the protection film 1 is a plastic film with a high surface hardness, the thickness of the protection film 1 is 0.1-1 mm, the thickness of the back adhesive layer is 0.05-1 mm and the interval between the convex parts is 0.05-0.5 mm.

An embodiment example of this invention is described above. It is necessary to understand that this invention is not limited to the above specific embodiment mode, technical persons in this field can make various variations or modifications within the range of Claim and this will not influence the essential content of this invention.

What is claimed is:

1. A screen protection application film comprising a protection film (1), a back adhesive layer (2), and a backing paper (3), in which the back side of the protection film (1) includes a screen protection area (11) and a panel protection area (12), the front side of the back adhesive layer (2) is bonded to the back side of the protection film (1), the front side of the backing paper (3) connects with the back side of the protection film (1) through the back adhesive layer (2), the extending plane of the back adhesive layer (2) is only limited to the panel protection area (12), the protection film (1) extends toward the back side direction to form multiple convex parts (10) and there is a gap (9) between the screen protection area (11) and the backing paper (3).

2. The screen protection application film as described in claim 1, wherein the heights of the convex parts (10) is less than or equal to the thickness of the back adhesive layer (2).

3. The screen protection application film as described in claim 1, wherein the convex parts (10) distributes in any of the following shapes to form a dot array:
Fold line shape;
Grid shape;
Concentric ring shape; and
Multi-point radiating line shape.

4. The screen protection application film as described in claim 2, wherein the convex parts (10) distributes in any of the following shapes to form a dot array:
Fold line shape;
Grid shape;
Concentric ring shape; and
Multi-point radiating line shape.

5. The screen protection application film as described in claim 1, wherein the convex parts (10) is formed by pressing.

6. The screen protection application film as described in claim 4, wherein the convex parts (10) is formed by pressing.

7. The screen protection application film as described in claim 1, wherein an interval exists between the convex parts (10).

8. The screen protection application film as described in claim 6, wherein an interval exists between the convex parts (10).

9. The screen protection application film as described in claim 1, wherein the interval between the convex parts (10) is 0.05-0.5 mm.

10. The screen protection application film as described in claim 8, wherein the interval between the convex parts (10) is 0.05-0.5 mm.

11. The screen protection application film as described in claim 1, wherein the thickness of the back adhesive layer is 0.05-1 mm and the heights of the convex parts is 0.005-0.5 mm.

12. The screen protection application film as described in claim 10, wherein the thickness of the back adhesive layer is 0.05-1 mm and the heights of the convex parts is 0.005-0.5 mm.

13. The screen protection application film as described in claim 1, wherein the thickness of the protection film (1) is 0.1-1 mm and the thickness of the backing paper (3) is 0.1-1 mm.

14. The screen protection application film as described in claim 12, wherein the thickness of the protection film (1) is 0.1-1 mm and the thickness of the backing paper (3) is 0.1-1 mm.

15. The screen protection application film as described in claim 1, further comprising a printing layer (4) and the printing layer (4) being placed between the protection film (1) and the back adhesive layer (2).

16. The screen protection application film as described in claim 2, further comprising a printing layer (4) and the printing layer (4) being placed between the protection film (1) and the back adhesive layer (2).

17. The screen protection application film as described in claim 14, further comprising a printing layer (4) and the printing layer (4) being placed between the protection film (1) and the back adhesive layer (2).

18. The screen protection application film as described in claim 1, wherein the convex parts (10) is in hemispherical shape, prism shape or cone shape.

19. The screen protection application film as described in claim 2, wherein the convex parts (10) is in hemispherical shape, prism shape or cone shape.

20. The screen protection application film as described in claim 17, wherein the convex parts (10) is in hemispherical shape, prism shape or cone shape.
